(19) United States
(12) Patent Application Publication
(10) Pub. No.: US 2012/0050119 A1
(43) Pub. Date: Mar. 1, 2012

(54) Long Term Evolution Antenna

(75) Inventors: Ying-Chih Wang, Kuei Shan Hsiang (TW); Jui-Teng Cheng, Kaohsiung City (TW)

(73) Assignee: Quanta Computer Inc.

(21) Appl. No.: 13/020,576

(22) Filed: Feb. 3, 2011

(30) Foreign Application Priority Data
Aug. 26, 2010 (TW) 099128633

(51) Int. Cl. H01Q 21/30

(52) U.S. Cl. 343/728

(57) ABSTRACT

A long term evolution antenna includes a dielectric substrate, a primary antenna structure disposed on a surface of the dielectric substrate, and a metal plate disposed on the dielectric substrate and connected to the primary antenna structure. The primary antenna structure includes a trunk section, and a first conductor arm, a second conductor arm and a loop conductor which all extend from the trunk section. The metal plate is connected to the first conductor arm and the second conductor arm so as to form a first radiator section for resonation in a first frequency band with the first conductor arm and a second radiator section for resonation in a second frequency band with the second conductor arm. The loop conductor extends from the trunk section to form a loop for resonation in a third frequency band.

### CROSS-REFERENCE TO RELATED APPLICATION

This application claims priority of Taiwanese Application No. 099128633, filed on Aug. 26, 2010.

### BACKGROUND OF THE INVENTION

1. Field of the Invention

The present invention relates to an antenna, more particularly to a long term evolution multi-band antenna.

2. Description of the Related Art

Long Term Evolution (LTE) technology is the latest mobile network technology. The LTE specification provides a downlink peak rate of at least 100 Mbit/s and an uplink peak rate of at least 50 Mbit/s in a bandwidth of 20 MHz, and supports older mobile network technologies such as the present 3G system. The LTE technology enables service providers to provide wireless communication services in a more economical way, and outperforms the present 3G system. LTE standard covers different frequency bands defined by different countries as shown in Table 1 with ranges from 698 to 960 MHz, 1710 to 2170 MHz, and 2500 to 2700 MHz. Furthermore, a majority of notebook computers today has GPS functionality. Thus, an antenna capable of operating in the aforementioned LTE frequency bands and GPS frequency bands with adequate operation bandwidth is the subject of this invention.

TABLE 1

| Operating | UL Frequencies | DL Frequencies | |
|---|---|---|---|
| Band | (MHz) | (MHz) | Region |
| Band I | 1920-1980 | 2110-2170 | Europe, Asia, |
| | | | Oceania |
| Band II | 1850-1910 | 1930-1990 | Americas |
| Band III | 1710-1785 | 1805-1880 | Europe |
| Band IV | 1710-1755 | 2110-2155 | Americas |
| Band V | 824-849 | 869-894 | USA, Australia |
| Band VI | 830-840 | 875-885 | Japan |
| Band VII | 2500-2570 | 2620-2690 | Europe |
| Band VIII | 880-915 | 925-960 | Europe |
| Band IX | 1749.9-1784.9 | 1844.9-1879.9 | Japan |
| Band X | 1710-1770 | 2110-2170 | Europe |
| Band XI | 1427.9-1425.9 | 1475.9-1500.9 | Japan |
| Band XII | 698-716 | 728-746 | USA, Canada |
| Band XIII | 777-787 | 746-756 | USA, Canada |
| Band XIV | 788-798 | 758-768 | USA, Canada |
| Band XVII | 704-716 | 734-746 | USA, Canada |

### SUMMARY OF THE INVENTION

Therefore, an object of the present invention is to provide a long term evolution (LTE) antenna capable of covering multiple operation bandwidths.

Accordingly, a LTE antenna of the present invention includes a dielectric substrate, a primary antenna structure disposed on a surface of the dielectric substrate, and a metal plate disposed on the dielectric substrate and connected to the primary antenna structure.

The primary antenna structure includes a trunk section, and a first conductor arm, a second conductor arm and a loop conductor which all extend from the trunk section. The trunk section is for feeding with radio frequency signals, and has a first trunk end and a second trunk end, which is opposite to the first trunk end. The first conductor arm extends from the first trunk end, and has a first arm end located at a first side of the dielectric substrate. The second conductor arm extends from the first trunk end, and has a second arm end located at the first side of the dielectric substrate. The first and second conductor arms extend away from each other. The loop conductor has a first conductor end connected to the second trunk end, and a second conductor end adjacent to the first conductor end. The loop conductor forms a loop between the first and second conductor ends.

The metal plate is disposed at the first side of the dielectric substrate, and is substantially perpendicular to the dielectric substrate. The metal plate is connected to the first arm end and the second arm end so as to form a first radiator section with the first conductor arm and a second radiator section with the second conductor arm.

Preferably, the primary antenna structure further includes a grounding conductor which is disposed on a second side of the dielectric substrate opposite to the first side, and which is connected to the second conductor end. The LTE antenna further includes a coaxial cable, which includes a signal line connected to the trunk section and a grounding line connected to the grounding conductor.

Preferably, the primary antenna structure further includes a conductive copper foil connected to the grounding conductor.

Preferably, the first conductor arm has a length greater than that of the second conductor arm. The first radiator section is capable of resonating in a first frequency band, and the second radiator section is capable of resonating in a second frequency band higher than the first frequency band. The loop conductor is capable of resonating in a third frequency band higher than the second frequency band.

Preferably, the primary antenna structure further includes an extension conductor which is spaced apart from the second conductor arm, and which is connected and substantially perpendicular to an end of the metal plate so as to form the second radiator section with the second conductor arm and the metal plate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of the long term evolution (LTE) antenna of the present invention;

FIG. 2 is another perspective view of the LTE antenna of the preferred embodiment from a different viewing angle;

FIG. 3 is a schematic view illustrating dimensions of preferred embodiment;

FIG. 4 illustrates a placement position of the LTE antenna of the preferred embodiment on a notebook computer;

FIG. 5 is a Voltage Standing Wave Ratio (VSWR) plot of the LTE antenna of the preferred embodiment;

FIG. 6 illustrates radiation patterns of the LTE antenna of the preferred embodiment operating at 700 MHz;

FIG. 7 illustrates radiation patterns of the LTE antenna of the preferred embodiment operating at 824 MHz;

FIG. 8 illustrates radiation patterns of the LTE antenna of the preferred embodiment operating at 915 MHz;

FIG. 9 illustrates radiation patterns of the LTE antenna of the preferred embodiment operating at 1575 MHz;

FIG. 10 illustrates radiation patterns of the LTE antenna of the preferred embodiment operating at 1710 MHz;

FIG. 11 illustrates radiation patterns of the LTE antenna of the preferred embodiment operating at 1930 MHz; and

FIG. 12 illustrates radiation patterns of the LTE antenna of the preferred embodiment operating at 2600 MHz.

### DETAILED DESCRIPTION OF THE PREFERRED EMBODIMENT

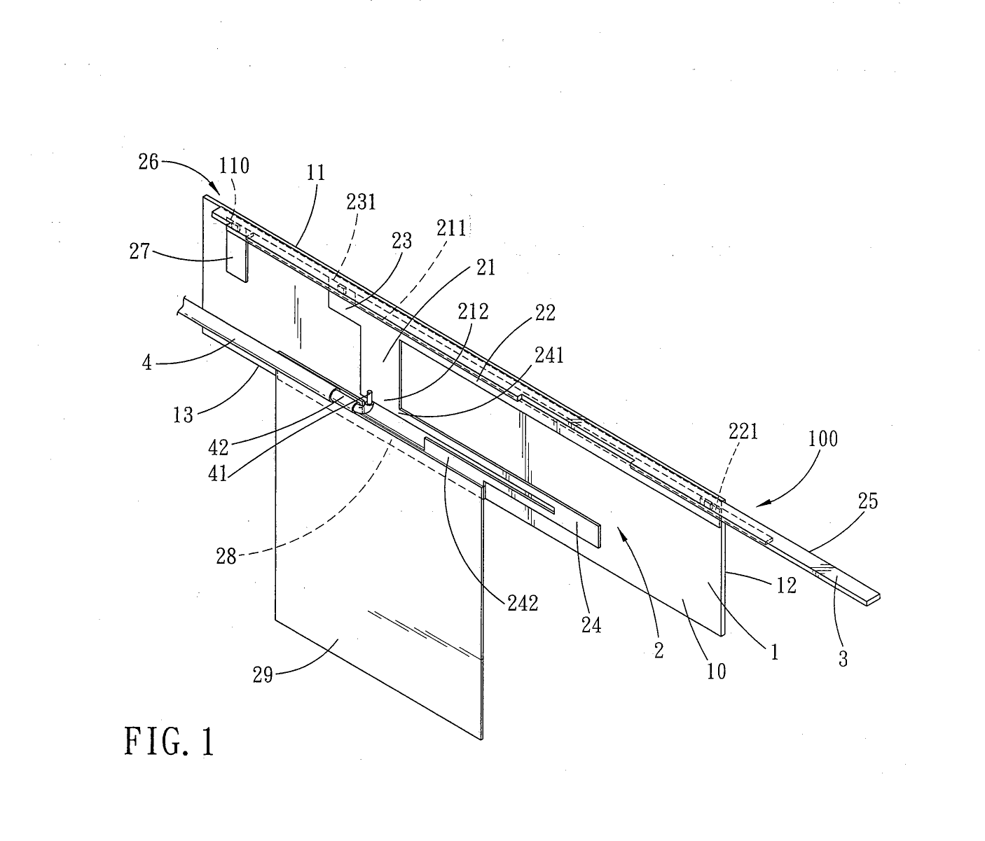

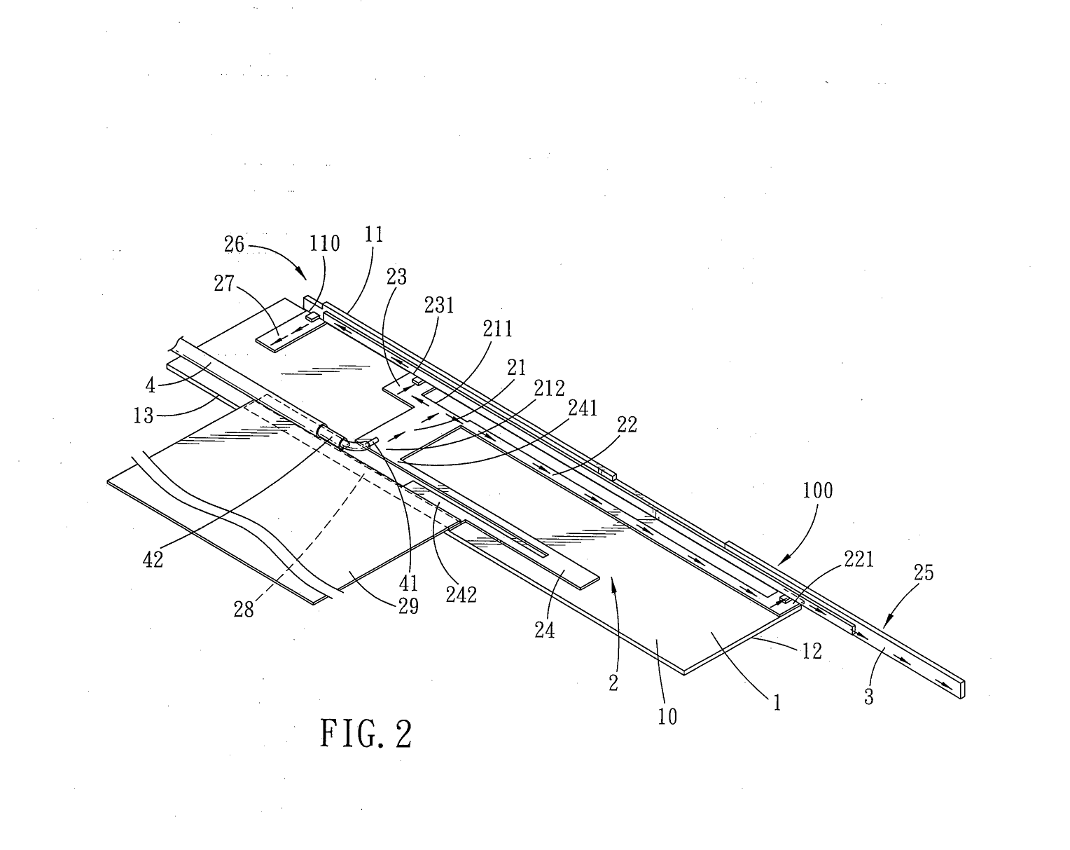

Referring to FIG. 1 and FIG. 2, a preferred embodiment of a long term evolution (LTE) antenna of the present invention is illustrated. The LTE antenna 100 of this embodiment includes a dielectric substrate 1, a primary antenna structure 2, and a metal plate (an iron piece) 3.

The primary antenna structure 2 is disposed on a surface 10 of the dielectric substrate 1, and includes a trunk section 21, a first conductor arm 22, a second conductor arm 23 and a loop conductor 24.

The trunk section 21 is a substantially rectangular board body. The trunk section 21 is for feeding with radio frequency signals, and has a first trunk end 211 and a second trunk end 212, which is opposite to the first trunk end 211.

The first conductor arm 22 extends from the first trunk end 211, and has a first arm end 221 located at a first side 11 of the dielectric substrate 1. In this embodiment, the first conductor arm 22 is adjacent to the first side 11, and extends substantially parallel with the first side 11 and toward another side 12, which is proximate to the first side 11, of the dielectric substrate 1. Subsequently, the first conductor arm 22 further extends at an angle toward the first side 11, and forms the first arm end 221 at the first side 11.

The second conductor arm 23 extends from the first trunk end 211 of the trunk section 21, and has a second arm end 231 located at the first side 11 of the dielectric substrate 1. The first conductor arm 22 and the second conductor arm 23 extend away from each other. In this embodiment, the second conductor arm 23 extends a short distance from the first trunk end 211 and substantially parallel with the first side 11, and extends at an angle toward the first side 11 to form the second arm end 231 at the first side 11.

The loop conductor 24 has a first conductor end 241 connected to the second trunk end 212, and a second conductor end 242 adjacent to the first conductor end 241. The loop conductor 24 forms a loop between the first conductor end 241 and the second conductor end 242.

The metal plate 3, in a shape of a long strop in this embodiment, is disposed at the first side 11 of the dielectric substrate 1, and is substantially perpendicular to the dielectric substrate 1. The metal plate 3 is connected to the first arm end 221 and the second arm end 231 so as to form a first radiator section 25 with the first conductor arm 22 and a second radiator section 26 with the second conductor arm 23. Moreover, the second radiator section 26 has an overall length. In order to change the overall length of the second radiator section 26 for operation in a specific frequency band, the primary antenna structure 2 of this embodiment further includes an extension conductor 27 which is spaced apart from the second conductor arm 23, and which has an end extending toward the first side 11 of the dielectric substrate 1 for connecting and being substantially perpendicular to an end 110 of the metal plate 3 so as to form the second radiator section 26 with the second conductor arm 23 and the metal plate 3.

Furthermore, the primary antenna structure 2 further includes a grounding conductor 28 which is disposed on a second side 13 of the dielectric substrate 1 opposite to the first side 11, and which is connected to the second conductor end 242 of the loop conductor 24. The LTE antenna 100 further includes a coaxial cable 4, which includes a signal line 41 connected to the trunk section 21 and a grounding line 42 connected to the grounding conductor 28.

Moreover, in order to increase a grounding area of the LTE antenna 100, the preferred embodiment may further include a conductive copper foil 29 connected to the grounding conductor 28.

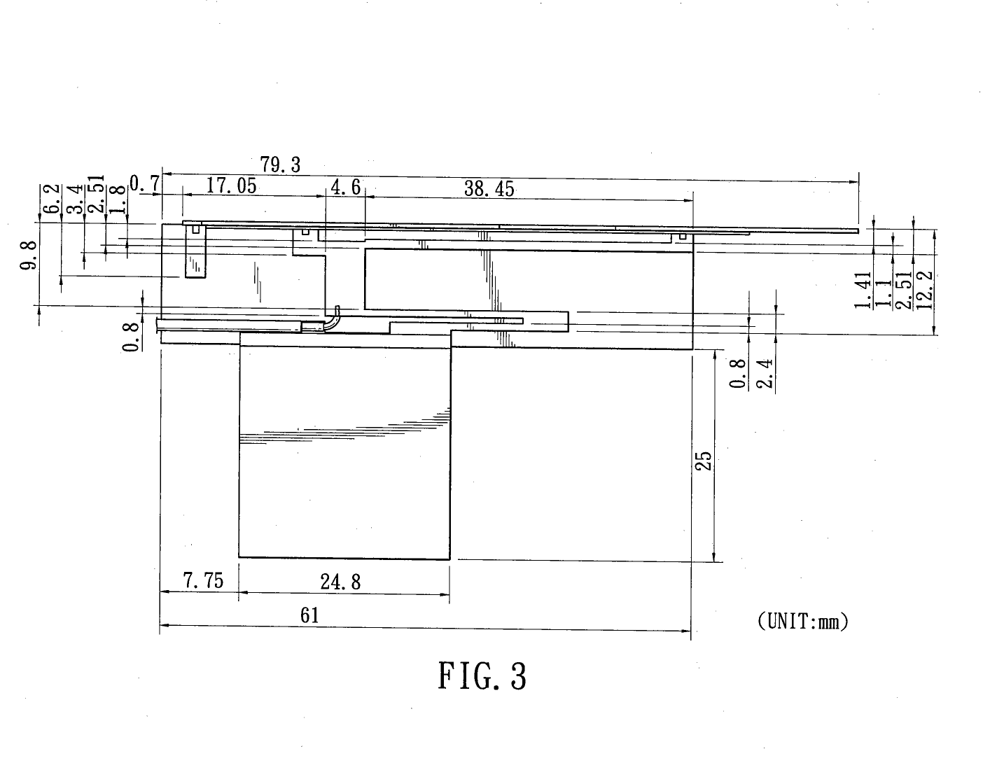

In this embodiment, the first radiator section 25 has an overall length greater than that of the second radiator section 26. The overall length of the first radiator section 25 is designed to make the first radiator section 25 capable of resonating in a first frequency band ranging from 698˜960 MHz. The overall length of the second radiator section 26 is designed to make the second radiator section 26 capable of resonating in a second frequency band, which is higher than the first frequency band, and which ranges from 1710˜2170 MHz. The loop conductor 24 has an overall length designed to make the loop conductor 24 capable of resonating in a third frequency band, which is higher than the second frequency band, and which ranges from 2500˜2700 MHz. The LTE antenna 100 of the preferred embodiment has an overall size of 82×14×3 mm³. Referring to FIG. 3, detailed dimensions of the LTE antenna 100 are illustrated.

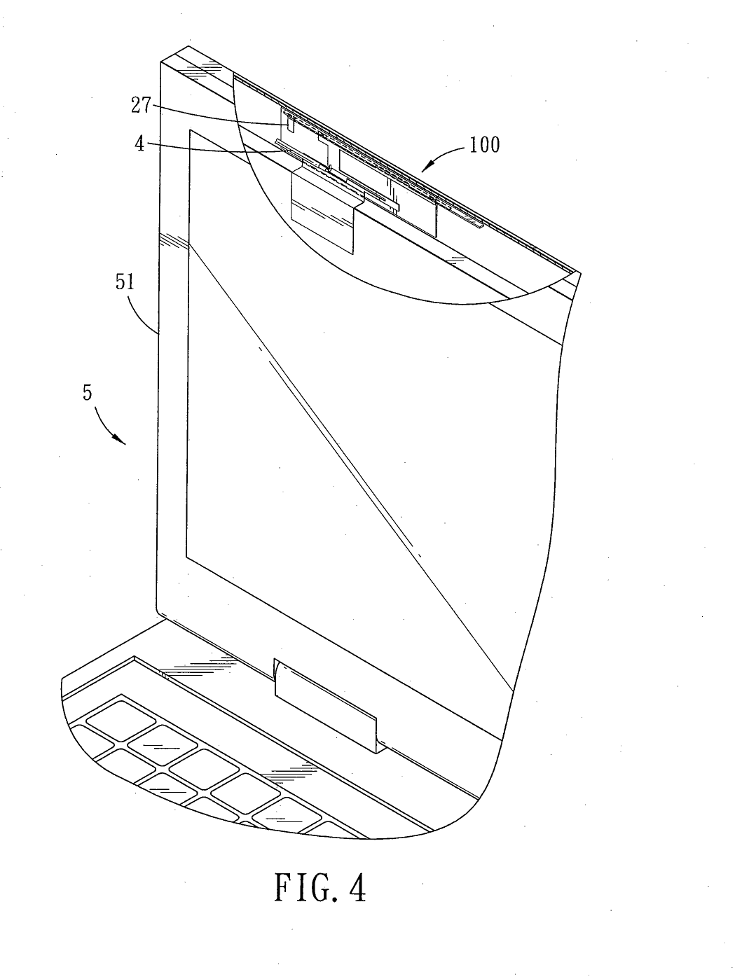

Referring to FIG. 4, the LTE antenna 100 of the preferred embodiment is usually disposed at an edge above a display, in a cover body 51 of a notebook computer 5.

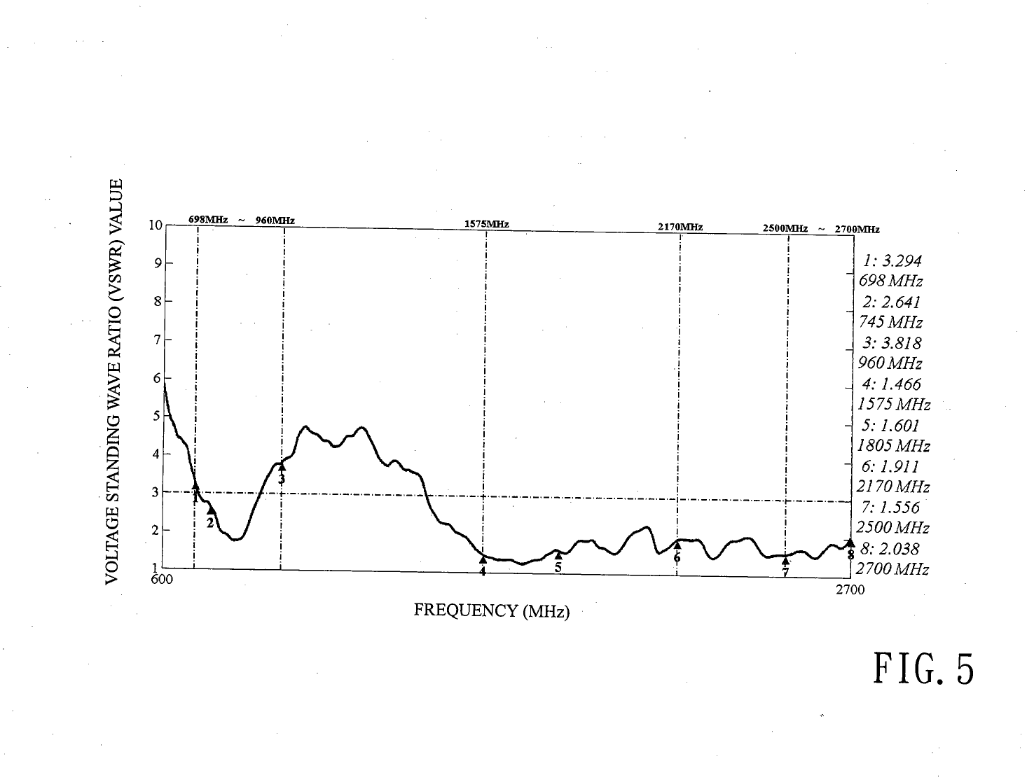

Referring to FIG. 5, a Voltage Standing Wave Ratio (VSWR) plot of the LTE antenna 100 of the preferred embodiment is illustrated. It is shown in FIG. 5 that the LTE antenna 100 may be capable of operating not only in LTE operation frequency bands ranging from 698-960 MHz, 2170˜2700 MHz, 2500˜2700 MHz, etc., but also in a GPS operation frequency band at 1575.42 MHz so as to satisfy a need for a GPS function of current notebook computers. Furthermore, values of VSWR at the aforementioned operation frequency bands, which include 1575 MHz and frequencies ranging from 698˜960 MHz, 2170˜2700 MHz and 2500˜2700 MHz, are all not greater than 4 so as to satisfy requirements for antenna radiation efficiency in the industry.

Referring to the following Table 2, total radiated power (Tot. Rad. Pwr.) and radiation efficiency (Efficiency) of the LTE antenna 100 of the preferred embodiment are illustrated.

TABLE 2

| Frequency | Tot. Rad. Pwr. | Efficiency |
|---|---|---|
| (MHz) | (dBm) | (%) |
| 700 | −5.24 | 29.95 |
| 715 | −5.04 | 31.32 |
| 730 | −4.95 | 31.98 |
| 745 | −4.69 | 33.99 |
| 760 | −4.00 | 39.80 |
| 775 | −3.15 | 48.39 |
| 790 | −3.29 | 46.93 |
| 805 | −3.75 | 42.18 |
| 820 | −4.36 | 36.67 |
| 824 | −4.59 | 34.73 |
| 836.6 | −4.82 | 32.93 |
| 849 | −4.60 | 34.71 |
| 869 | −4.51 | 35.40 |
| 881.6 | −4.58 | 34.87 |
| 880 | −4.54 | 35.14 |
| 894 | −4.66 | 34.22 |
| 897.4 | −4.74 | 33.58 |
| 915 | −5.30 | 29.48 |
| 925 | −5.14 | 30.59 |
| 942.4 | −5.17 | 30.38 |
| 960 | −5.41 | 28.78 |
| 1575 | −2.70 | 53.75 |
| 1710 | −1.49 | 71.03 |
| 1747.8 | −0.92 | 80.92 |
| 1785 | −1.85 | 65.38 |
| 1805 | −2.40 | 57.55 |
| 1842.8 | −3.32 | 46.57 |
| 1850 | −3.37 | 46.01 |
| 1880 | −3.25 | 47.33 |
| 1910 | −3.59 | 43.76 |
| 1920 | −3.57 | 43.97 |
| 1930 | −2.96 | 50.60 |
| 1950 | −2.84 | 52.02 |
| 1960 | −2.89 | 51.37 |
| 1980 | −3.17 | 48.16 |
| 1990 | −3.20 | 47.84 |
| 2110 | −3.41 | 45.58 |
| 2140 | −3.37 | 46.01 |
| 2170 | −3.82 | 41.45 |
| 2500 | −3.00 | 50.16 |
| 2520 | −3.02 | 49.85 |
| 2540 | −3.05 | 49.56 |
| 2560 | −2.98 | 50.36 |
| 2580 | −3.11 | 48.85 |
| 2600 | −2.68 | 54.00 |
| 2620 | −3.01 | 49.98 |
| 2640 | −3.31 | 46.66 |
| 2660 | −3.93 | 40.43 |
| 2680 | −4.00 | 39.82 |
| 2700 | −4.04 | 39.42 |

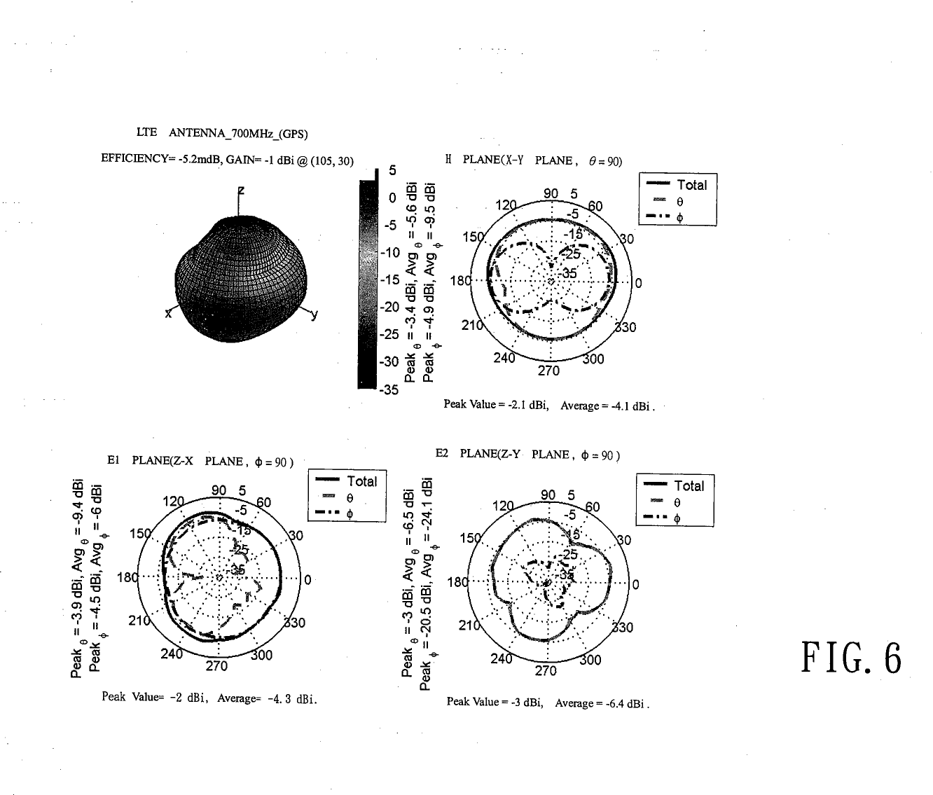

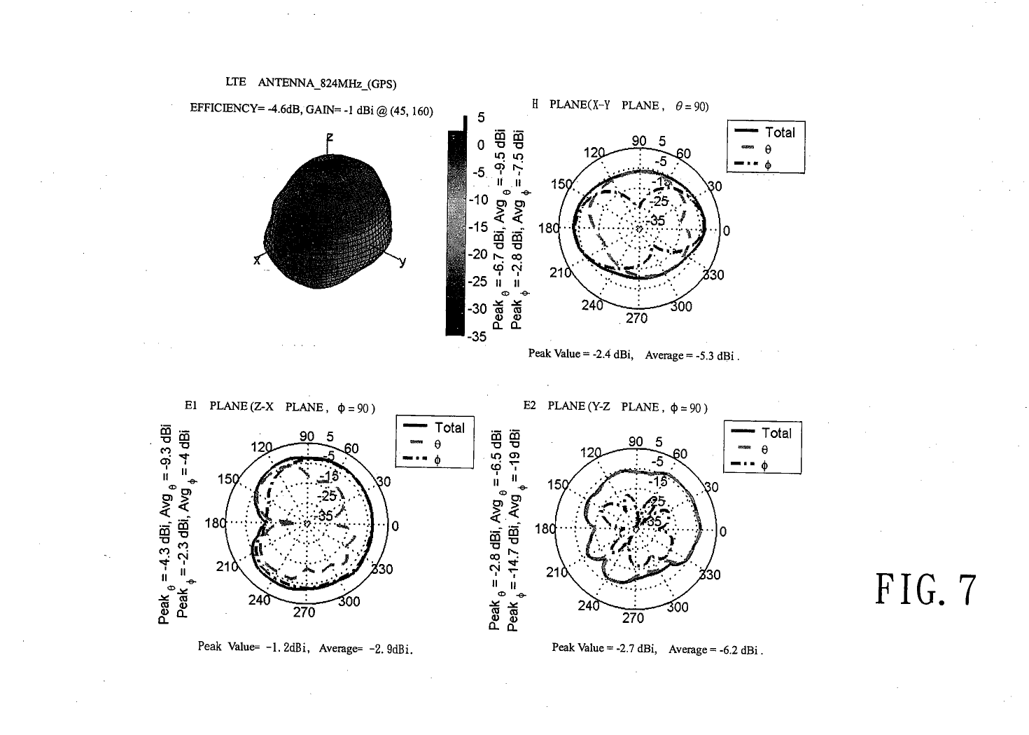

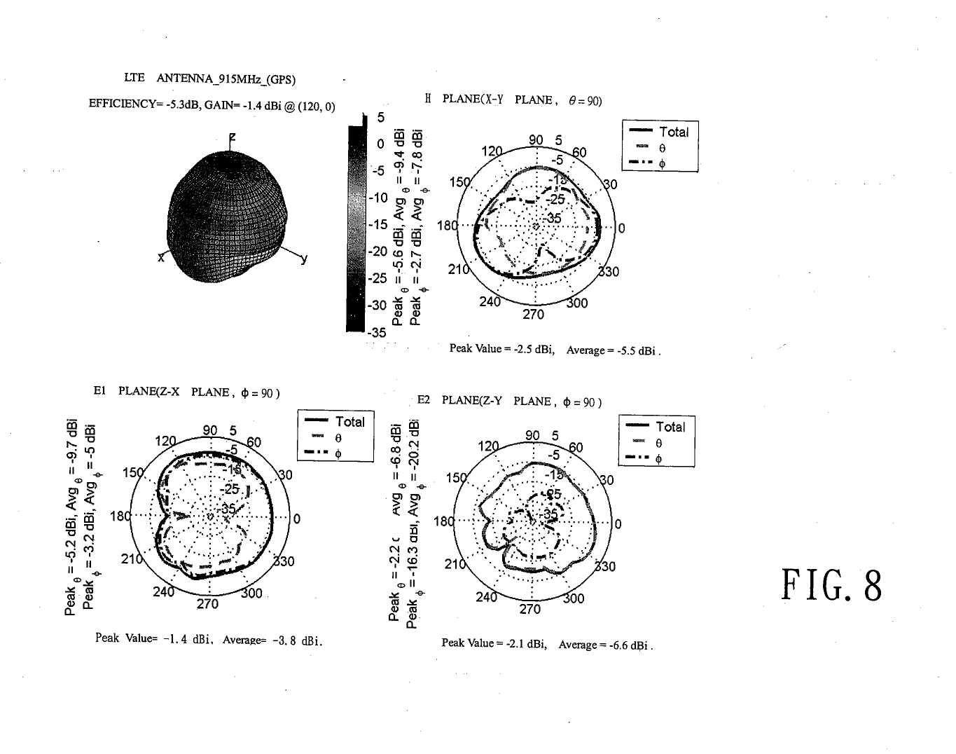

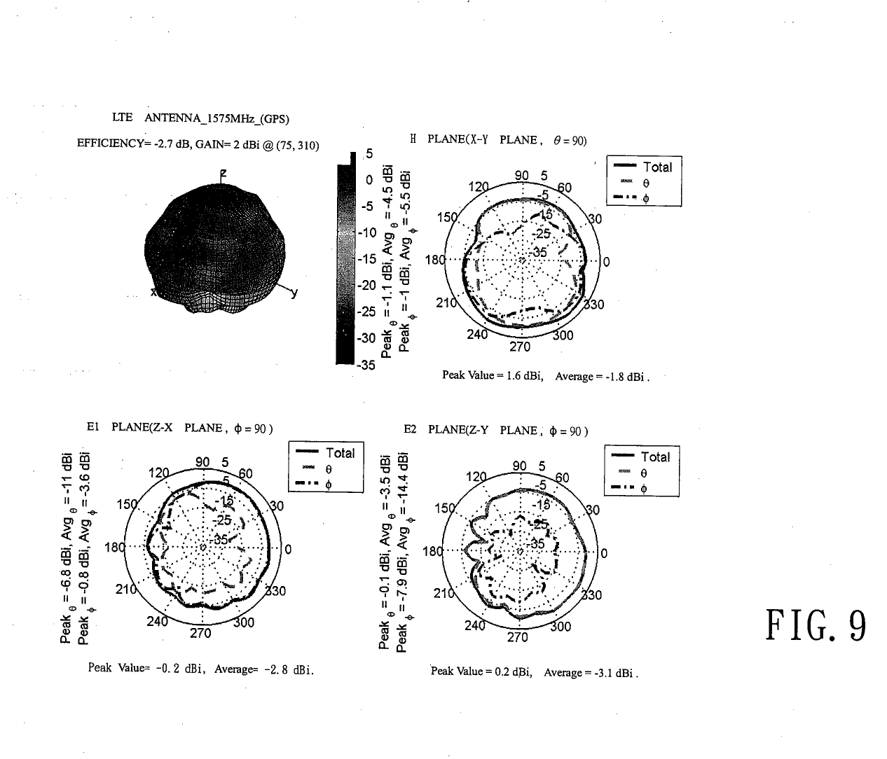

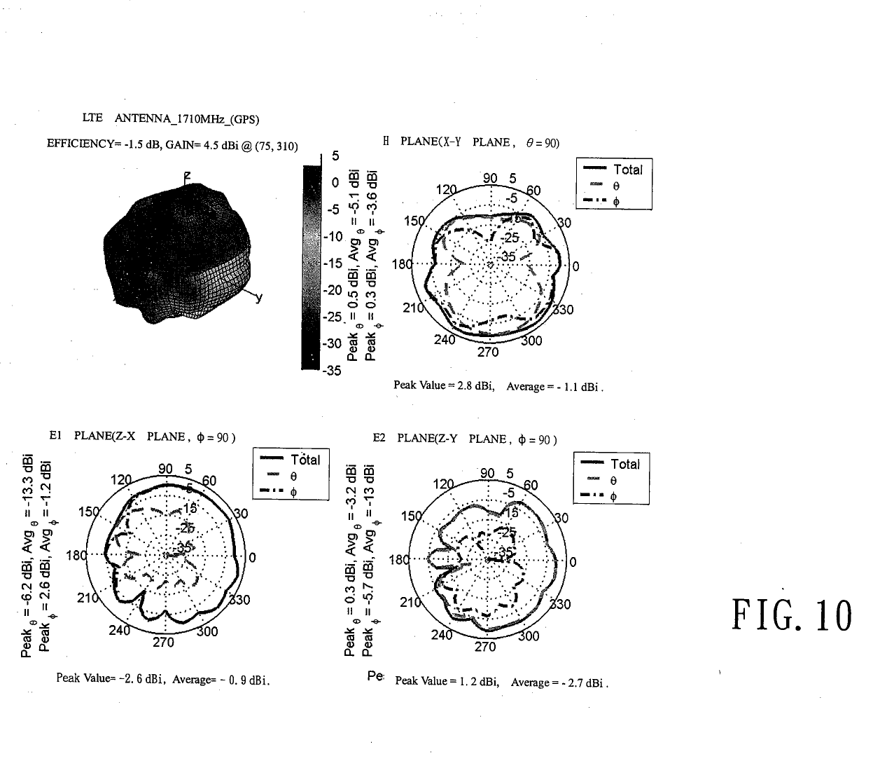

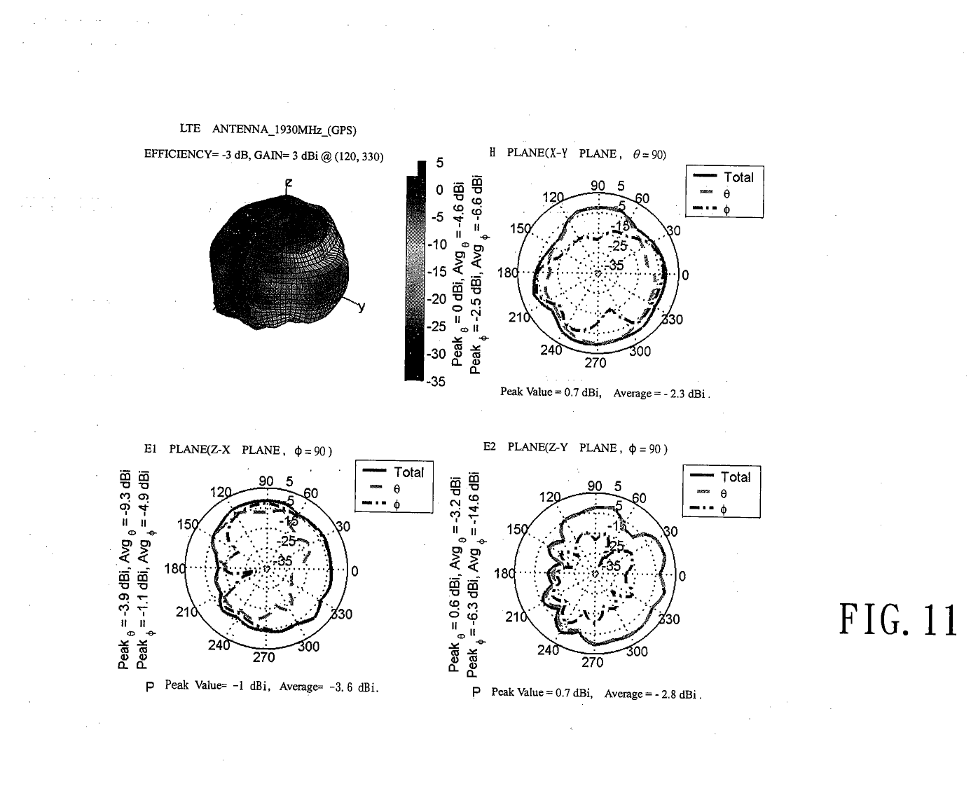

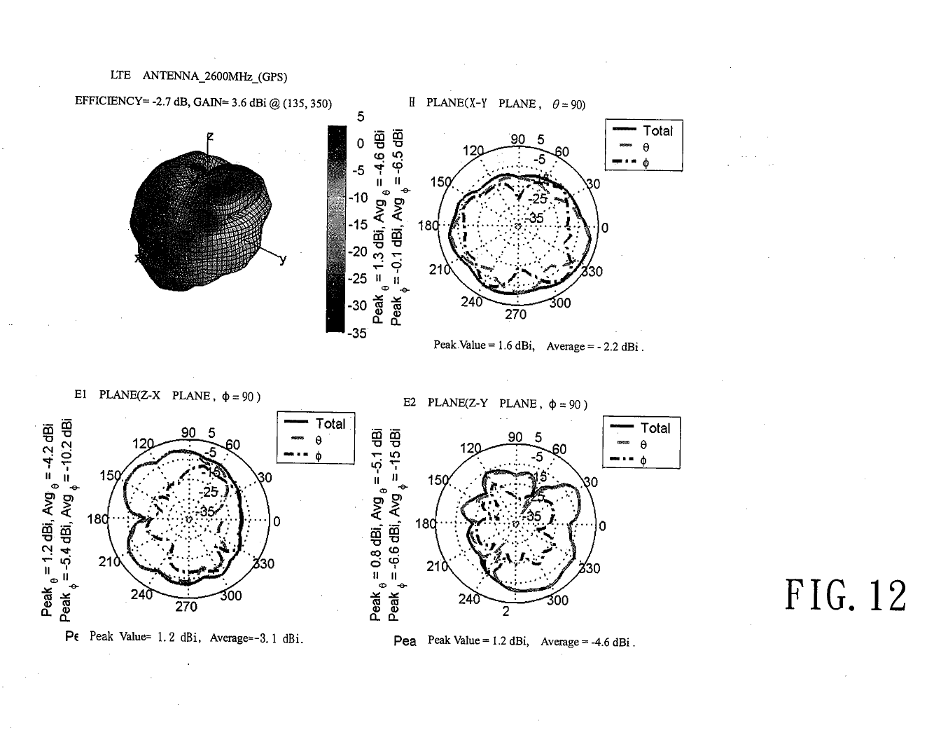

Referring to FIG. 6 to FIG. 12, radiation patterns of the LTE antenna 100 of the preferred embodiment in different operation frequencies are illustrated. It is shown in each of the figures from FIG. 6 to FIG. 12 that the radiation patterns of the LTE antenna 100 have relatively good omni-directionality.

In summary, the LTE antenna 100 of the preferred embodiment uses the metal plate 3 to increase a bandwidth of the first radiator section 25, and enable the second radiator section 26 to operate simultaneously in the GPS frequency band (1575.42 MHz) and the LTE frequency band ranging from 1710˜2170 MHz. Moreover, the LTE antenna 100 of the preferred embodiment further uses the loop conductor 24 to adjust high frequency impedance such that the loop conductor 24 is capable of operating in the LTE high frequency band ranging from 2500˜2700 MHz. Thus, an effect of covering the GPS frequency band and different LTE operation frequency bands specified in different territories is achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A long term evolution (LTE) antenna comprising:
a dielectric substrate;
a primary antenna structure disposed on a surface of said dielectric substrate, said primary antenna structure including:
a trunk section for feeding with radio frequency signals, said trunk section having a first trunk end and a second trunk end opposite to said first trunk end;
a first conductor arm extending from said first trunk end, and having a first arm end located at a first side of said dielectric substrate;
a second conductor arm extending from said first trunk end, and having a second arm end located at said first side of said dielectric substrate;
said first and second conductor arms extending away from each other; and
a loop conductor having a first conductor end connected to said second trunk end, and a second conductor end adjacent to said first conductor end, said loop conductor forming a loop between said first and second conductor ends; and
a metal plate disposed at said first side of said dielectric substrate and being substantially perpendicular to said dielectric substrate, said metal plate being connected to said first arm end and said second arm end so as to form a first radiator section with said first conductor arm and a second radiator section with said second conductor arm.

2. The LTE antenna as claimed in claim 1, wherein said primary antenna structure further includes a grounding conductor which is disposed on a second side of said dielectric substrate opposite to said first side, and which is connected to said second conductor end, the LTE antenna further comprising a coaxial cable, said coaxial cable including a signal line connected to said trunk section, and a grounding line connected to said grounding conductor.

3. The LTE antenna as claimed in claim 2, wherein said primary antenna structure further includes a conductive copper foil connected to said grounding conductor.

4. The LTE antenna as claimed in claim 1, wherein said first conductor arm has a length greater than that of said second conductor arm, said first radiator section being capable of resonating in a first frequency band, said second radiator section being capable of resonating in a second frequency band higher than the first frequency band, said loop conductor being capable of resonating in a third frequency band higher than the second frequency band.

5. The LTE antenna as claimed in claim 4, wherein said primary antenna structure further includes an extension conductor which is spaced apart from said second conductor arm, and which is connected and substantially perpendicular to an end of said metal plate so as to form said second radiator section with said second conductor arm and said metal plate.

6. The LTE antenna as claimed in claim 1, wherein said primary antenna structure further includes an extension conductor which is spaced apart from said second conductor arm, and which is connected and substantially perpendicular to an end of said metal plate so as to form said second radiator section with said second conductor arm and said metal plate.

7. The LTE antenna as claimed in claim 4, wherein the first frequency band ranges from 698 MHz to 960 MHz, the second frequency band includes 1575 MHz and a frequency range from 2170 MHz to 2700 MHz, and the third frequency band ranges from 2500 MHz to 2700 MHz.
